(19) United States
(12) Patent Application Publication
(10) Pub. No.: US 2022/0229181 A1
(43) Pub. Date: Jul. 21, 2022

(54) LASER RANGEFINDER

(71) Applicant: ULTRACKER TECHNOLOGY CO., LTD., Taoyuan City (TW)

(72) Inventor: Ming-Jung Yu, Taoyuan City (TW)

(21) Appl. No.: 17/154,040

(22) Filed: Jan. 21, 2021

(51) Int. Cl. G01S 17/08; G01S 7/481; G01S 7/4912; G01S 7/4911

(52) U.S. Cl. CPC G01S 17/08; G01S 7/4911; G01S 7/4912; G01S 7/4817

(57) ABSTRACT

A laser rangefinder, including: a housing; a first rotational mechanism, mounted to the housing, including a first shaft and a first driving device, the first driving device driving the first shaft to rotate about a first axial direction; a reflector, connected with the first shaft; a laser rangefinding module, mounted within the housing, including a transmitting module and a receiving module; a second rotational mechanism, mounted to the housing, including a second shaft and a second driving device, the second driving device driving the second shaft to rotate about a second axial direction, the first axial direction and the second axial direction being non-parallel; wherein the first shaft is configured to drive the reflector to rotate on a scan plane, the first rotational mechanism, the laser rangefinding module and the second rotational mechanism are located at a same side of the scan plane.

### BACKGROUND OF THE INVENTION

### Field of the Invention

The present invention relates to a laser rangefinder.

### Description of the Prior Art

The laser rangefinder is a very convenient instrument for measuring distance. Its principle is to project laser light to the object to be ranged and calculate the time when it receives the reflected light from the object to be ranged, and thus the distance between the laser rangefinder and the object is obtained. However, the conventional rangefinder can only perform distance-measuring at a fixed angle at a time, and the rangefinder should be manually adjusted to perform distance-measuring at various angles, which is time-consuming and inconvenient.

The present invention is, therefore, arisen to obviate or at least mitigate the above-mentioned disadvantages.

### SUMMARY OF THE INVENTION

The main object of the present invention is to provide a laser rangefinder which is simple and compact in structure.

To achieve the above and other objects, the present invention provides a laser rangefinder, including: a housing; a first rotational mechanism, mounted to the housing, including a first shaft and a first driving device which are movable with each other, the first driving device driving the first shaft to rotate about a first axial direction relative to the housing; a reflector, connected with the first shaft; a laser rangefinding module, mounted within the housing, including a transmitting module and a receiving module, laser light from the transmitting module being projected to the reflector and reflected to an outside of the housing, the receiving module configured to receive reflection of the laser light from the outside of the housing which is reflected from the reflector; a second rotational mechanism, mounted to the housing, including a second shaft and a second driving device, the second driving device driving the second shaft to rotate about a second axial direction, the first axial direction and the second axial direction being non-parallel; wherein the first shaft is configured to drive the reflector to rotate on a scan plane, the first rotational mechanism, the laser rangefinding module and the second rotational mechanism are located at a same side of the scan plane.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a partial perspective view of a preferable embodiment of the present invention;

FIG. 3 is a cross-sectional view of a preferable embodiment of the present invention;

FIG. 4 is a side view of FIG. 2;

FIG. 5 is a cross-sectional view of FIG. 4;

FIG. 6 is a partial view of FIG. 5, showing the paths of laser light during rangefinding; and

FIG. 7 is a partial cross-sectional view of FIG. 2.

### DETAILED DESCRIPTION OF THE PREFERRED EMBODIMENTS

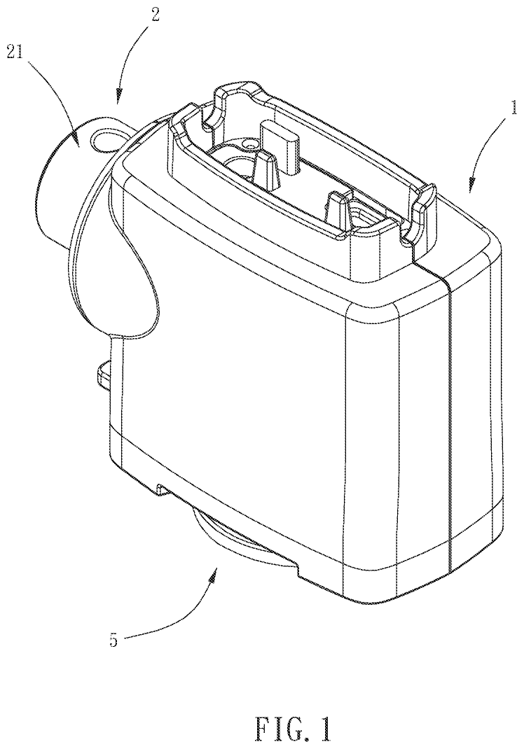

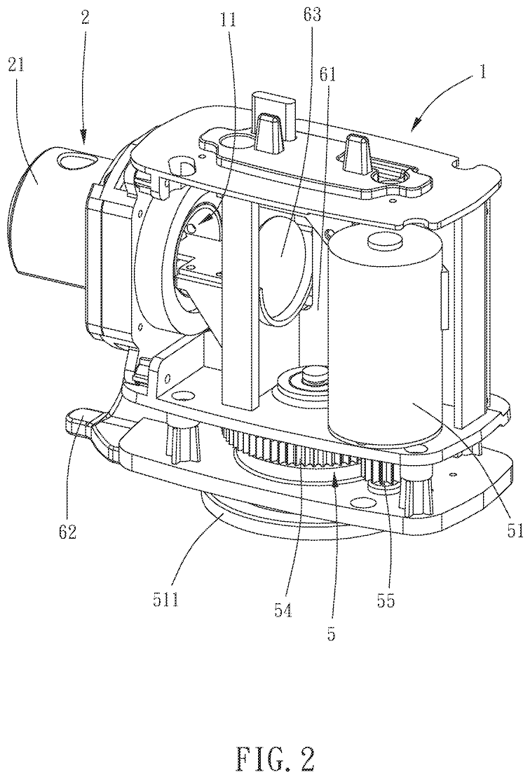

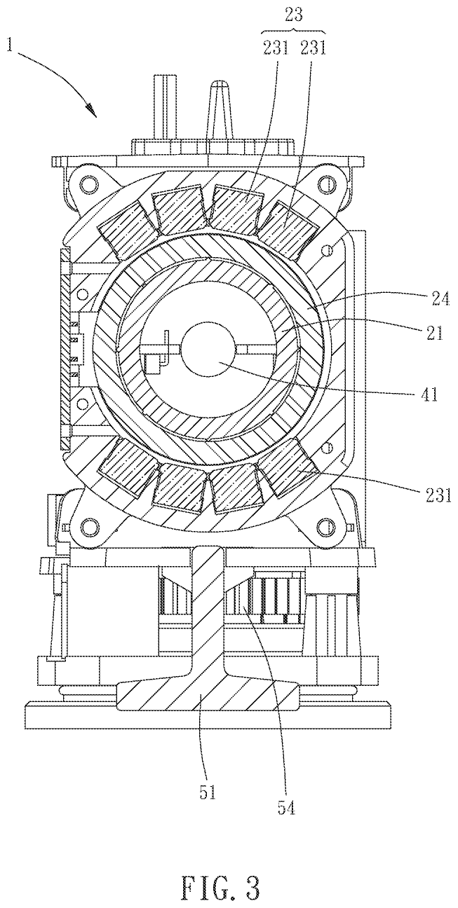

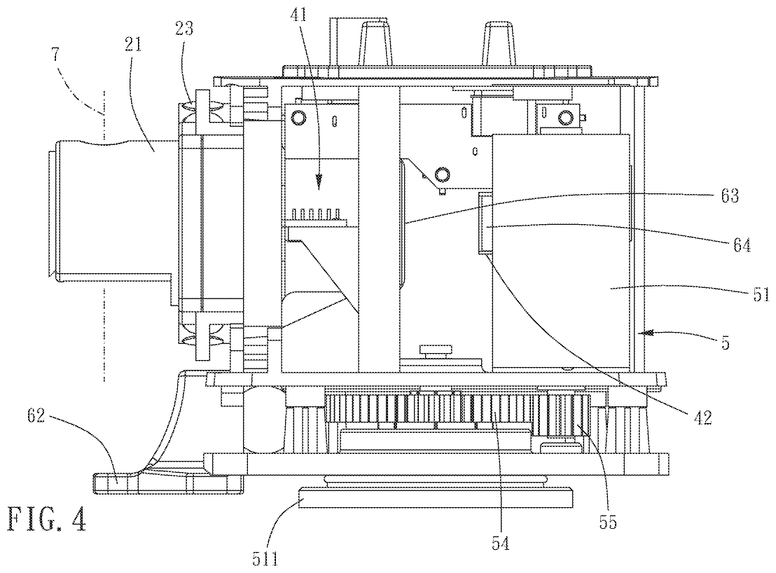

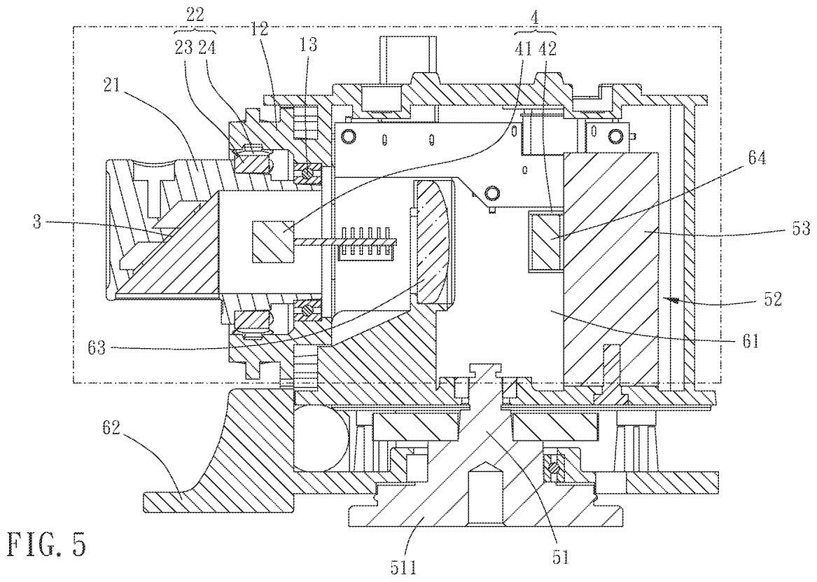

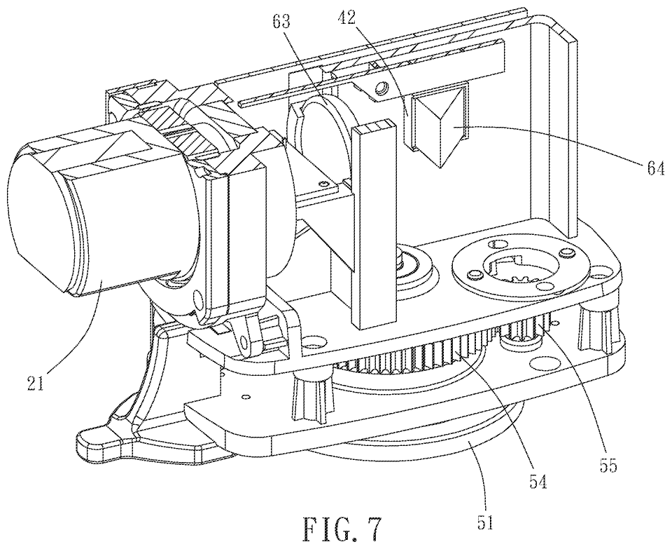

Please refer to FIGS. 1 to 7 for a preferable embodiment of the present invention. A laser rangefinder of the present invention includes a housing 1, a first rotational mechanism 2, a reflector 3, a laser rangefinding module 4 and a second rotational mechanism 5.

The first rotational mechanism 2 is mounted to the housing 1, the first rotational mechanism 2 includes a first shaft 21 and a first driving device 22 which are movable with each other, and the first driving device 22 drives the first shaft 21 to rotate about a first axial direction relative to the housing 1.

The reflector 3 is connected with the first shaft 21.

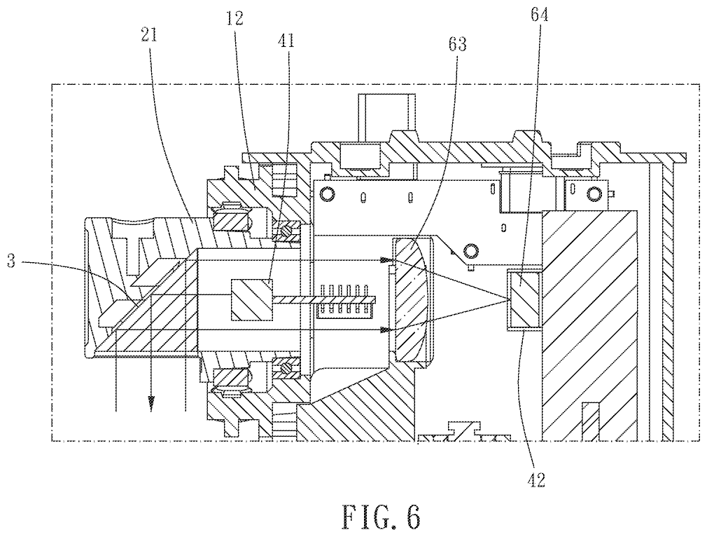

The laser rangefinding module 4 is mounted within the housing 1, and the laser rangefinding module 4 includes a transmitting module 41 and a receiving module 42. Laser light from the transmitting module 41 is projected to the reflector 3 and reflected to an outside of the housing 1. The receiving module 42 is configured to receive reflection of the laser light from the outside of the housing 1 which is reflected from the reflector 3, for distance-calculating. In this embodiment, a focusing lens 63 is disposed in the housing 1 and located between the reflector 3 and the receiving module 42, for focusing the laser light to the receiving module 42 (FIG. 6).

The second rotational mechanism 5 is mounted to the housing 1, and the second rotational mechanism 5 includes a second shaft 51 and a second driving device 52. The second driving device 52 drives the second shaft 51 to rotate about a second axial direction, and the first axial direction and the second axial direction are non-parallel.

The first shaft 21 is configured to drive the reflector 3 to rotate on a scan plane 7 so that the reflector 3 is rotatable on the scan plane 7 for 360 degrees. The first rotational mechanism 2, the laser rangefinding module 4 and the second rotational mechanism 5 are located at a same side of the scan plane 7, and the laser rangefinder is therefore simple and compact in structure.

Since the first axial direction and the second axial direction are parallel, the first driving device 22 and the second driving device 52 can operate to make the laser light to be reflected from the reflector 3 at any angles.

Preferably, the first axial direction and the second axial direction are perpendicular to each other, and the reflector 3 is exposed to the outside of the housing 1 in the first axial direction. Preferably, the second axial direction is in parallel to a vertical direction which is perpendicular to the ground. The second shaft 51 includes a support 511, and the support 511 is disposed through the housing 1 and exposed to the outside of the housing 1 for abutting on a datum plane (such the ground). When the second shaft 51 rotates relative to the housing 1, the housing 1 rotates relative to datum plane.

Specifically, the second driving device 52 includes a motor 53, and the motor 53 is connected and movable with the second shaft 51. The second shaft 51 is connected and movable with a first gear 54, the motor 53 is connected and movable with a second gear 55, the first gear 54 and the second gear 55 are engaged with each other, and the first gear 54 has a diametric dimension larger than a diametric dimension of the second gear 55 so as to reduce the rotational speed of the second shaft 51.

Specifically, the first shaft 21 is rotatably inserted to the housing 1, and the first driving device 22 includes an electromagnetic assembly 23 and a magnetic assembly 24. One of the first shaft 21 and the housing 1 includes the electromagnetic assembly 23, and the other of the first shaft 21 and the housing 1 includes the magnetic assembly 24, wherein a magnetic field is produced by the electromagnetic assembly 23 to force the magnetic assembly 24 so that the first shaft 21 rotates relative to the housing 1, which reduces noise, is stable, avoids the shake of the housing 1, and provides good accuracy.

In this embodiment, the magnetic assembly 24 is an annular magnetic member which is disposed around and movable with the first shaft 21. The electromagnetic assembly 23 includes a plurality of inductances 231 fixedly mounted to the housing 1, and the plurality of inductances 231 are diametrically arranged relative to the annular magnetic member. As the plurality of inductances 231 are supplied with power, the plurality of inductances 231 produce magnetic force to rotate the annular magnetic member.

The housing 1 includes a through hole 11 surrounded by an annular wall 12 extending in the first axial direction, and the first shaft 21 is rotatably inserted in the through hole 11. The reflector 3 is disposed on an end of the first shaft 21 remote from the housing 1, a bearing 13 is disposed on an end of the annular wall 12, and an end of the first shaft 21 is inserted in the bearing 13 so that the first shaft 21 is stably rotatable. The plurality of inductances 231 is disposed on the annular wall 12.

A board 61 is disposed in the housing 1, the transmitting module 41 and the receiving module 42 are disposed on the board 61, and the first shaft 21 is a hollow tube for the laser light to pass therethrough. Preferably, the board 61 includes a prism 64, the prism 64 is located at a side of the focusing lens 63 opposite to the reflector 3, and the prism 64 is configured to reflect the laser light which passes through the focusing lens 63, to the receiving module 42.

Preferably, a calibration member 62 is mounted on a bottom of the housing 1 and extends in the first axial direction, and the calibration member 62 corresponds to the reflector 3 in vertical direction. Specifically, a distance between the laser rangefinder and the calibration member 62 is firstly obtained, and as the relative positions of the laser rangefinder and the calibration member 62 is not equal to a predetermined distance, the laser rangefinder should be calibrated.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A laser rangefinder, including:
a housing;
a first rotational mechanism, mounted to the housing, including a first shaft and a first driving device which are movable with each other, the first driving device driving the first shaft to rotate about a first axial direction relative to the housing;
a reflector, connected with the first shaft;
a laser rangefinding module, mounted within the housing, including a transmitting module and a receiving module, laser light from the transmitting module being projected to the reflector and reflected to an outside of the housing, the receiving module configured to receive reflection of the laser light from the outside of the housing which is reflected from the reflector;
a second rotational mechanism, mounted to the housing, including a second shaft and a second driving device, the second driving device driving the second shaft to rotate about a second axial direction, the first axial direction and the second axial direction being non-parallel;
wherein the first shaft is configured to drive the reflector to rotate on a scan plane, and the first rotational mechanism, the laser rangefinding module and the second rotational mechanism are located at a same side of the scan plane.

2. The laser rangefinder of claim 1, wherein the first axial direction and the second axial direction are perpendicular to each other, and the reflector is exposed to the outside of the housing in the first axial direction.

3. The laser rangefinder of claim 1, wherein the second axial direction is perpendicular to a vertical direction which is perpendicular to the ground, the second shaft includes a support, and the support is disposed through the housing and exposed to the outside of the housing for abutting on a datum plane.

4. The laser rangefinder of claim 1, wherein the second driving device includes a motor, and the motor is connected and movable with the second shaft.

5. The laser rangefinder of claim 4, wherein the second shaft is connected and movable with a first gear, the motor is connected and movable with a second gear, the first gear and the second gear are engaged with each other, and the first gear has a diametric dimension larger than a diametric dimension of the second gear.

6. The laser rangefinder of claim 1, wherein the first shaft is rotatably inserted to the housing, the first driving device includes an electromagnetic assembly and a magnetic assembly, one of the first shaft and the housing includes the electromagnetic assembly, the other of the first shaft and the housing includes the magnetic assembly, and a magnetic field is produced by the electromagnetic assembly to force the magnetic assembly so that the first shaft rotates relative to the housing.

7. The laser rangefinder of claim 6, wherein the magnetic assembly is an annular magnetic member which is disposed around and movable with the first shaft, the electromagnetic assembly includes a plurality of inductances fixedly mounted to the housing, and the plurality of inductances are diametrically arranged relative to the annular magnetic member.

8. The laser rangefinder of claim 7, wherein the housing includes a through hole surrounded by an annular wall extending in the first axial direction, the first shaft is rotatably inserted in the through hole, the reflector is disposed on an end of the first shaft remote from the housing, a bearing is disposed on an end of the annular wall, an end of the first shaft is inserted in the bearing, and the plurality of inductances is disposed on the annular wall.

9. The laser rangefinder of claim 1, wherein a board is disposed in the housing, the transmitting module and the receiving module are disposed on the board, and the first shaft is a hollow tube for the laser light to pass therethrough.

10. The laser rangefinder of claim 2, wherein the second axial direction is perpendicular to a vertical direction which is perpendicular to the ground, the second shaft includes a support, and the support is disposed through the housing and exposed to the outside of the housing for abutting on a datum plane; the second driving device includes a motor, and the motor is connected and movable with the second shaft; the second shaft is connected and movable with a first gear, the motor is connected and movable with a second gear, the first gear and the second gear are engaged with each other, and the first gear has a diametric dimension larger than a diametric dimension of the second gear; the first shaft is rotatably inserted to the housing, the first driving device includes an electromagnetic assembly and a magnetic assembly, one of the first shaft and the housing includes the electromagnetic assembly, the other of the first shaft and the housing includes the magnetic assembly, and a magnetic field is produced by the electromagnetic assembly to force the magnetic assembly so that the first shaft rotates relative to the housing; the magnetic assembly includes an annular magnetic member which is disposed around and movable with the first shaft, the electromagnetic assembly includes a plurality of inductances fixedly mounted to the housing, and the plurality of inductances are diametrically arranged relative to the annular magnetic member; the housing includes a through hole surrounded by an annular wall extending in the first axial direction, the first shaft is rotatably inserted in the through hole, the reflector is disposed on an end of the first shaft remote from the housing, a bearing is disposed on an end of the annular wall, an end of the first shaft is inserted in the bearing, and the plurality of inductances is disposed on the annular wall; a board is disposed in the housing, the transmitting module and the receiving module are disposed on the board, the first shaft is a hollow tube for the laser light to pass therethrough; a calibration member is mounted on a bottom of the housing and extends in the first axial direction, and the calibration member corresponds to the reflector in the vertical direction; a focusing lens is disposed in the housing and located between the reflector and the receiving module; the board includes a prism, the prism is located at a side of the focusing lens opposite to the reflector, and the prism is configured to reflect the laser light which passes through the focusing lens, to the receiving module.
